(19) United States
(12) Patent Application Publication
(10) Pub. No.: US 2025/0139750 A1
(43) Pub. Date: May 1, 2025

(54) SYSTEMS AND METHODS FOR DETERMINING CONTENT QUALITY

(71) Applicant: Comcast Cable Communications, LLC, Philadelphia, PA (US)

(72) Inventors: Ryan MCMURRAY, Arvada, CO (US); Matthew EBERSVILLER, Evergreen, CO (US); Jonathan KIRKOVICH, Parker, CO (US)

(21) Appl. No.: 18/498,905

(22) Filed: Oct. 31, 2023

(51) Int. Cl. G06T 7/00

(52) U.S. Cl. CPC G06T 7/0002; G06T 2207/10016; G06T 2207/20081; G06T 2207/20084; G06T 2207/30168

(57) ABSTRACT

Methods and systems for determining content quality are disclosed. At least one distortion associated with a content item may be determined. Based on the content item comprising a source content item, it may be determined that the at least one distortion comprises at least one intentional artifact. A quality score associated with the content item may be determined. The at least one intentional artifact may have no effect on the quality score or a lower effect on the quality score than an unintentional artifact associated with the content item.

### BACKGROUND

The quality of content, such as videos, may be determined using no-reference video quality metrics. No-reference video quality metrics may comprise algorithms configured to measure a distortion level associated with content. Such algorithms may determine a lower quality score for content items associated with a higher level of distortion. However, not all distortions are indicative of low-quality content. Therefore, improved techniques for determining content quality are desirable.

### SUMMARY

Methods and systems for determining content quality are disclosed. Some distortions (e.g., video artifacts) in content items are intentionally included in the content item by the creator of the content item, while other distortions are not intentionally included in the content item by the creator of the content item. Unlike unintentional distortions, which may be indicative of a lower video quality for a content item, intentional distortions may not be indicative of a lower video quality. Accordingly, intentional distortions in the content item may be assigned less weight than the unintentional artifacts in the content item when determining a video quality score for the content item.

A content item may be classified based on quality type. The content item may be classified as being associated with a first quality type if the content item is an original content item (e.g., source content item, contribution quality content item). The content may be an original content item if the content item is an uncompressed source copy of the content item. The content item may be classified as being associated with a second quality type if the content item is not an original content item. The quality of the content item may be determined by performing a video quality assessment. The video quality assessment may be different depending on whether the content item is classified as being associated with the first quality type or the second quality type. One or more parameters in the video quality assessment may be weighted differently depending on whether the content item is classified as being associated with the first quality type or the second quality type.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example method.

FIG. 3 is an example method.

FIG. 4 is an example method.

FIG. 5 is an example method.

FIG. 6 is an example method.

FIG. 7 is an example method.

FIG. 8 is a block diagram of an example computing device.

### DETAILED DESCRIPTION OF ILLUSTRATIVE EMBODIMENTS

Improved methods and systems for determining content quality, such as video content quality, are disclosed. No-reference video quality metrics may comprise algorithms configured to determine content quality based on distortions (e.g., video artifacts, impairments) associated with the content. A no-reference video quality metric may analyze a content item to detect and measure the distortions associated with the content item. The no-reference video quality metric may determine that a content item associated with a higher distortion level is of lower quality, and vice versa.

However, not all distortions (e.g., video artifacts, impairments) are indicative of low-quality content. Some distortions may be intentionally included in a content item, such as by the content creator (e.g., the entity that created or produced the content item). For example, a content creator may intentionally cause a scene in a content item to appear grainy in order to make the scene appear like it was filmed a long time ago, or a content creator may intentionally cause a scene in a content item to appear blurry if a character depicted in the scene is dizzy. Distortions (e.g., video artifacts, impairments) that are intentionally included in a content item by the entity that created the content item may herein be referred to as “intentional distortions” or “intentional artifacts.” Intentional distortions or artifacts may not be indicative of low-quality content. By contrast, some distortions (e.g., video artifacts, impairments) associated with the content item may not be intentionally included in the content item. Distortions that are not intentionally included in a content item by the content creator may herein be referred to as “unintentional distortions” or “unintentional artifacts.” Unintentional distortions or artifacts may be caused, for example, by encoding, re-encoding, transcoding, compressing, re-compressing, de-compressing, and/or transmitting a content item. Unintentional distortions or artifacts may be indicative of low-quality content.

No-reference video quality metrics may be unable to distinguish between intentional distortions (e.g., intentional artifacts) and unintentional distortions (e.g., unintentional artifacts). Thus, a no-reference video quality metric may erroneously determine a low quality score for a content item based on intentional distortions associated with the content item. Accordingly, improved techniques for determining content quality are needed.

Described herein are improved techniques for determining content quality. A content item (e.g., image, video, movie, show, clip, advertisement, etc.) may include one or more intentional distortion(s) and/or one or more unintentional distortions. A video quality score for the content item may be determined. The intentional distortion(s) may have a lower (e.g., lesser) effect on the video quality score than the unintentional distortion(s). For example, the intentional distortion(s) may cause less of a negative impact on the video quality score than the unintentional distortion(s).

A content item may be a source (e.g., original) content item if the content item has not been processed (e.g., edited, compressed, de-compressed, and/or otherwise modified by an entity other than the creator of the content item). If a content item is a source content item, the distortions in the content item may be intentional distortions. Content items may be classified by quality type. Content items may be classified by quality type using a machine learning model. If a content item is classified as being associated with a first quality type, this may indicate that the content item is a source content item. If a content item is classified as being associated with the first quality type, this may indicate that the content item is associated with at least one first type of distortion. The at least one first type of distortion may comprise at least one intentional distortion. If a content item is classified as being associated with a second quality type, this may indicate that the content item is not a source content item (e.g., not the original uncompressed source copy). A content item may not be an original content item if the content item has been processed (e.g., edited, compressed, de-compressed, and/or otherwise modified by an entity other than the creator of the content item). If a content item is classified as being associated with the second quality type, this may indicate that the content item is associated with at least one second type of distortion. The at least one second type of distortion may comprise at least one unintentional distortion.

Data indicating whether a content item is classified as being associated with the first quality type or the second quality type may be sent to a no-reference video quality metric. The no-reference video quality metric may use this data to determine a quality score associated with the content item. To determine the quality score associated with the content item, the no-reference video quality metric may lower the weight assigned to and/or ignore the intentional artifact(s) in the content item. For example, if the data associated with a content item indicates that the content item is classified as the first quality type, the no-reference video quality metric may not assign a negative score to one or more types of intentional distortions associated with the content item. As such, the intentional artifact(s) may have a lower effect on the quality score than unintentional artifact(s) in the content item. Accordingly, the no-reference video quality metric may not erroneously determine that the content item is of low quality based on the intentional distortions associated with the content item.

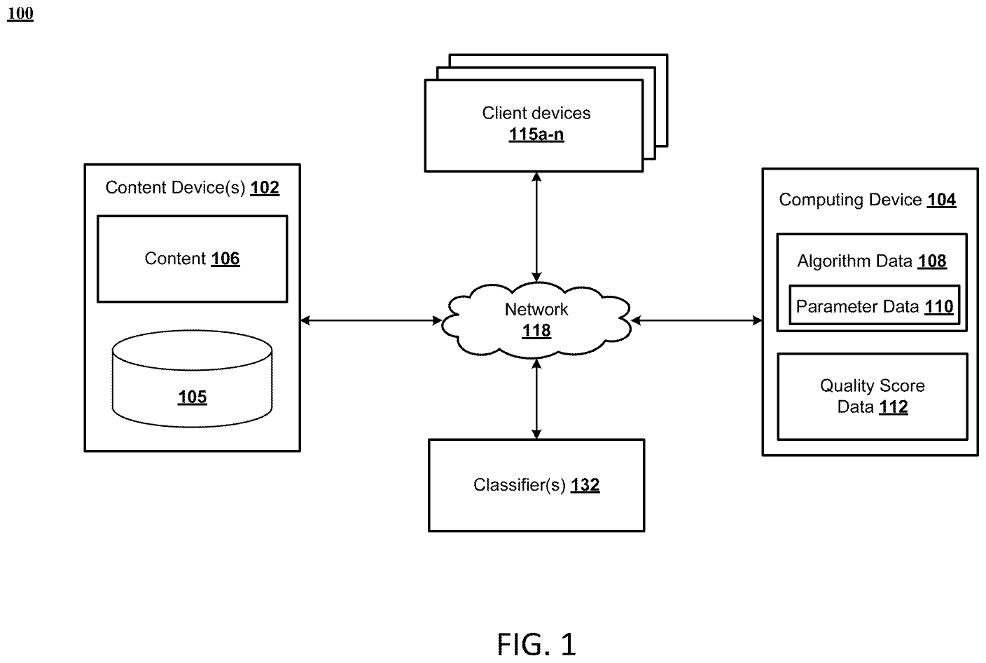

FIG. 1 shows a block diagram of an example system 100. The system 100 may comprise at least one content device 102, a computing device 104, a plurality of client devices 115a-n, and at least one classifier 132. It should be noted that while the singular term device is used herein, it is contemplated that some devices may be implemented as a single device or a plurality of devices (e.g., via load balancing). The computing device 104, each of the plurality of client devices 115a-n, and/or the classifier(s) 132 may each be implemented as one or more computing devices. Any device disclosed herein may be implemented using one or more computing nodes, such as virtual machines, executed on a single device and/or multiple devices. The content device(s) 102, the computing device 104, the plurality of client devices 115a-n, and the classifier(s) 132 may be in communication via a network 118.

The content device(s) 102 may be configured to distribute (e.g., provide, transmit) content 106 to the plurality of client devices 115a-n. The content 106 may be transmitted to the plurality of client devices 115a-n using any suitable protocol. The content 106 transmitted by the content device(s) 102 may include one or more content items. A content item may comprise, as an example, a video program. A video program may refer generally to any video content produced for viewer consumption. A video program may comprise video content produced for broadcast via over-the-air radio, cable, satellite, and/or the internet. A video program may comprise video content produced for digital video streaming, video-on-demand, and/or the like. A video program may comprise a television show or program. A video program series may comprise two or more associated video programs. For example, a video program series may include an episodic or serial television series. As another example, a video program series may include a documentary series, such as a nature documentary series. As yet another example, a video program series may include a regularly scheduled video program series, such as a nightly news program.

The content 106 may comprise content items associated with a first quality type. A content item that is associated with the first quality type may be an original content item (e.g., source content item, contribution quality content item). A content item may be an original content item if the content item has not been edited, compressed, de-compressed, and/or otherwise modified by an entity other than the creator of the content item. The content 106 may comprise content items associated with a second quality type. A content item that is associated with the second quality type may not be an original content item. A content item may not be an original content item if the content item has been edited, compressed, de-compressed, and/or otherwise modified by an entity other than the creator of the content item.

A content item may be associated with one or more distortions. The distortion(s) associated with a content item may comprise one or more of a basis pattern, blockiness, tearing, blurriness, color distortion, mosquito noise, white noise, graininess, ringing, flickering, floating, jerkiness, incorrect or incoherent captions or subtitles, and/or any other type of visual or auditory distortion. The distortions may comprise intentional distortions and/or unintentional distortions. As described above, intentional distortions may comprise distortions that were intentionally included in a content item, such as by the content creator (e.g., the entity that created or produced the content item). For example, a content creator may intentionally cause a scene in a content item to appear grainy in order to make the scene appear like it was filmed a long time ago, or a content creator may intentionally cause a scene in a content item to appear blurry if a character depicted in the scene is dizzy. Unintentional distortions may comprise distortions that were not intentionally included in the content item, such as by the content creator. Unintentional distortions may be caused, for example, by encoding, re-encoding, transcoding, compressing, re-compressing, de-compressing, transmitting, and/or re-transmitting a content item.

A content item may comprise both intentional and unintentional distortions. The creator of the content item may intentionally include one or more intentional distortions in the content item. The content item comprising the intentional distortion(s) may further comprise unintentional distortions. The unintentional distortions may be caused by transmission of the data that comprises the content item from one hard disk to another (e.g., over the internet, over a direct connection like USB cable, etc.). If the transmission is interrupted, the interruption may cause an unintentional distortion in the content item. If the storage medium on which the content item comprising the intentional distortion(s) is stored is degraded, this may cause an unintentional distortion of the content item. The storage medium may be degraded if the film gets dusty, scratched, discolored, magnetized, exposed to sunlight or heat (e.g., melted). The storage medium may be degraded if a hard disk fails in some way, such as if the hard disk has an unreadable (e.g., bad) sector.

The content device(s) 102 may comprise at least one database, such as the database(s) 105. The database(s) 105 may store data and/or metadata associated with the content 106. The database(s) 105 may store data and/or metadata associated each content item. The data and/or metadata associated with a content item may indicate one or more of a frame rate, resolution, audio bitrate, video bitrate, subtitle formats, a container format, a codec ID, a duration, a width, a height, a color space, a resolution, a chroma subsampling, a bit depth, a scan type, a compression mode, a stream size, and/or any other type of data or metadata associated with the content item.

Non-limiting examples of a content device(s) 102 include a television broadcast network, a cable television network, a satellite television network, an internet service provider (ISP), a computing device advertising network, a media distribution network, a cloud computing network, a local area network (LAN), a wide area network (WAN), or any combination thereof.

The content device(s) 102 may be configured to operate across physical device platforms and networks simultaneously. For example, the content 106 may be delivered by the content device(s) 102 (such as via one or more local content systems) to the plurality of user device 115a-n using standard network communication protocols (for instance, Ethernet or Wi-Fi) over an ISP network, standard telecommunication protocols (for instance, third Generation (3G), fourth Generation (4G), long-term evolution (LTE), or the like), and/or through a LAN, WAN and/or ISP network.

The plurality of client devices 115a-n may be configured to receive the content 106 from the content device(s) 102. The plurality of client devices 115a-n may comprise any one of numerous types of devices configured to effectuate content output and/or viewing. The plurality of client devices 115a-n may be configured to receive the content 106 and output the content 106 to a display device for consumer viewing.

Each of the plurality of client devices 115a-n may comprise a set-top box (STB), such as a cable STB, a digital video recorder (DVR) that receives and stores video content for later viewing, a television, a smart television, a personal computer (PC), a laptop computer, a mobile computing device, a smartphone, a tablet computing device, a home gateway, or the like. Each of the plurality of client devices 115a-n may combine any features or characteristics of the foregoing examples. For instance, a user device may include a cable STB with integrated DVR features.

The classifier(s) 132 may be configured to determine a classification indicative of a quality type associated with a content item. Determining the classification indicative of the quality type associated with the content item may comprise determining whether the content item is associated with the first quality type or the second quality type. Determining the classification indicative of the quality type associated with the content item may comprise classifying the content item as either being associated with the first quality type or the second quality type. The classifier(s) 132 may be associated with the content device(s) 102. The classifier(s) 132 may be associated with an entity other than the content device(s) 102. The content device(s) 102 and/or any other entity may use the classifier(s) 132 to determine whether a content item is associated with the first quality type or the second quality type. The classifier(s) 132 may be configured to send an indication of the classification indicative of the quality type associated with a content item to the computing device 104.

If a content item is classified as being associated with the first quality type, this may indicate that the content item is an original content item. Thus, determining that the content item is associated with the first quality type may comprise determining that the content item is associated with at least one first type of distortion. The at least one first type of distortion may comprise at least one intentional distortion. If a content item is classified as being associated with a second quality type, this may indicate that the content item is not an original content item (e.g., not the original uncompressed source copy). Thus, determining that the content item is associated with the second quality type may comprise determining that the content item is associated with at least one second type of distortion. The at least one second type of distortion may comprise at least one unintentional distortion.

The classifier(s) 132 may be configured to determine the classification indicative of the quality type associated with a content item based on at least a portion of the data and/or metadata stored in the database(s) 105. The classifier(s) 132 may determine the classification indicative of the quality type associated with a content item based on at least a portion of the data and/or metadata stored in the database(s) 105 that corresponds to that particular content item. The data and/or metadata stored in the database(s) 105 that corresponds to that particular content item may indicate one or more of a frame rate, resolution, audio bitrate, video bitrate, subtitle formats, a container format, a codec ID, a duration, a width, a height, a color space, a resolution, a chroma subsampling, a bit depth, a scan type, a compression mode, a stream size, any/or any other type of data or metadata associated with the content item. The classifier(s) 132 may classify the content item as either being associated with the first quality type or the second quality type based on any portion and/or combination of the corresponding data and/or metadata stored in the database(s) 105.

The classifier(s) 132 may comprise at least one machine learning model. The machine learning model(s) may be trained to determine the classification indicative of a quality type associated with a content item. The machine learning model(s) may be trained to determine the classification indicative of the quality type associated with the content item by classifying the content item as either being associated with the first quality type or the second quality type. Any suitable machine learning model may be employed. For example, the machine learning model(s) may be implemented using, or be based on, one or more deep learning models, such as convolutional neural networks (CNNs), recurrent neural networks (RNNs), long short term memory networks (LSTMs), generative adversarial networks (GANs), and/or multilayer perceptrons (MPLs). The machine learning model(s) may be implemented using, or be based on, a k-nearest neighbor algorithm, support vector machines (SVMs), cost-sensitive SVMs, naive Bayes classifiers, gradient boosting, decision trees (DTs), cost-sensitive DTs, logistic regression (LR), and/or cost-sensitive LR. The machine learning model(s) may be implemented using a cost-sensitive decision tree. As an example, the machine learning model may comprise a CNN comprising one or more convolutional layers and/or pooling layers. The convolutional and/or pooling layers may be followed by one or more fully connected layers, convolutional layers, normalization layer, activation function, and/or the like. As another example, the CNN may be based on and/or an implementation of ResNet, LeNet-5, VGG, AlexNet, or other neural network optimized for image processing.

The machine learning model(s) may be trained based on prior content items and data and/or metadata corresponding to the prior content items. The prior content items may comprise at least a portion of the content 106 and the data and/or metadata corresponding to the prior content items may comprise at least a portion of the data and/or metadata stored in the database(s) 105. The portion of the content 106 on which the machine learning model(s) may be trained may comprise a plurality of training content items. It may be known whether each of the plurality of training content items is associated with the first quality type or the second quality type. The portion of the data and/or metadata stored in the database(s) 105 on which the machine learning model(s) may be trained may comprise the data and/or metadata corresponding to the plurality of training content items. Collectively, the portion of the content 106 and the portion of the data and/or metadata stored in the database(s) 105 on which the machine learning model(s) may be trained may herein be referred to as “training data.” To train the machine learning model(s), the training data may be fed into the machine learning model(s). Feeding the training data into the machine learning model(s) may comprise inputting, via a training process configured to update one or more states, rules, filters, etc. of the machine learning model(s), the training data into the machine learning model(s). Based on the training data, the machine learning model(s) may learn how to classify a content item as being associated with the first quality type or the second quality type, given data and/or metadata associated with the content item. The machine learning model(s) may be trained by the content device(s) 102 and/or any other entity that has access to the training data.

The computing device 104 may be configured to determine a quality (e.g., video quality) associated with the content 106. The computing device 104 may be configured to determine a quality score indicative of the quality associated with each content item. The quality associated with a content item may indicate an amount of content degradation that may be perceived by a viewer of the content item. A content item of a higher quality (e.g., higher quality score) may be associated with a lower amount of degradation perceived by a viewer of the content item. A content item of a lower quality (e.g., lower quality score) may be associated with a higher amount of degradation that may be perceived by a viewer of the content item. Viewers may enjoy viewing high quality content more than they enjoy viewing low quality content. Thus, high quality content may be viewed more frequently and/or for longer durations than low quality content.

The computing device 104 may comprise a probe. The computing device 104 may comprise a monitoring device. The computing device 104 may be executed (e.g., run) on a server. The computing device 104 may be placed at any point in the content delivery path so long as the computing device 104 has access to the content.

To determine the quality associated with a content item, the computing device 104 may be configured to determine at least one distortion associated with the content item. The computing device 104 may be configured to determine distortions associated with the content item by analyzing the content item, such as each frame of the content item, at a pixel level. The computing device 104 may be configured to determine a duration associated with each determined distortion. The computing device 104 may be configured to determine a type of distortion associated with each determined distortion. The type of distortion associated with a determined distortion may indicate whether that distortion is a basis pattern, blockiness, blurriness, color distortion, mosquito noise, white noise, graininess, ringing, flickering, floating, jerkiness, incorrect or incoherent captions or subtitles, and/or any other type of visual or auditory distortion.

To determine the quality associated with a content item, the computing device 104 may be configured to determine a process for assessing a quality associated with the content item. The computing device 104 may receive an indication of the classification indicative of the quality type associated with the content item from the classifier(s) 132. The computing device 104 may be configured to determine the process for assessing the quality associated with the content item based on the classification indicative of the quality type associated with the content item.

The process for assessing the quality associated with the content item may comprise at least one algorithm configured to determine content quality based on distortions (e.g., impairments) associated with the content item. The computing device 104 may store algorithm data 108 (e.g., or processing data, classification data). The algorithm data 108 may indicate the at least one algorithm configured to determine content quality based on distortions (e.g., impairments) associated with the content item. The at least one algorithm may be associated with a plurality of parameters. Each of the plurality of parameters may be associated with a particular type of distortion. For example, a first parameter may be associated with mosquito noise, a second parameter may be associated with blockiness, a third parameter may be associated with blurriness, etc. The computing device 104 may store parameter data 110. The parameter data 110 may indicate each of the plurality of parameters and which type of distortion each of the parameters are associated with. To assess (e.g., determine) the quality associated with the content item, the computing device 104 may be configured to evaluate the at least one algorithm based on the algorithm data 108 and/or the parameter data 110.

Determining the process for assessing the quality associated with the content item may comprise adjusting a weight of a parameter associated with at least one type of distortion. If the classification indicative of the quality type associated with the content item indicates that the content item is associated with the first quality type, this may indicate that the content item is an original content item. If the content item is an original content item, this may indicate that the content item is associated with at least one first type of distortion. The at least one first type of distortion may comprise at least one intentional distortion. It may be undesirable to negatively score the intentional distortion(s) in an original content item, as the intentional distortion(s) are not indicative of low video quality.

Thus, if the content item is classified as being associated with the first quality type, adjusting a weight of a parameter associated with at least one type of distortion may comprise decreasing a weight of a parameter associated with at least one type of intentional distortion. Decreasing the weight of the parameter associated with the at least one type of intentional distortion may comprise adjusting the weight of the parameter associated with the at least one type of intentional distortion to zero. Decreasing the weight of the parameter associated with the at least one type of intentional distortion may prevent the intentional distortion(s) in the content item from being negatively scored during the quality assessment process. Data indicative of the decreased weight of the parameter associated with the at least one type of intentional distortion may be stored as parameter data 110.

A content item that is classified as being associated with the first quality type may include one or more unintentional distortions in addition to, or as an alternative to, the intentional distortion(s). For example, a content creator may intentionally cause a scene in a content item to appear grainy in order to make the scene appear like it was filmed a long time ago, but the content item may also include unintentional distortions, such as one or more of a basis pattern, blockiness, blurriness, color distortion, mosquito noise, white noise, ringing, flickering, floating, jerkiness, incorrect or incoherent captions or subtitles, and/or any other type of visual or auditory distortion. It may be desirable to increase the negative score assigned to the unintentional distortion(s) in an original content item, as the unintentional distortion(s) are indicative of low video quality.

Thus, if the content item is classified as being associated with the first quality type, adjusting a weight of a parameter associated with at least one type of distortion may comprise increasing a weight of a parameter associated with at least one type of unintentional distortion. The at least one type of unintentional distortion may comprise a type of unintentional distortion that is unlikely to be intentionally included in content, such as mosquito noise, white noise, ringing, flickering, floating, jerkiness, incorrect or incoherent captions or subtitles, etc. Increasing the weight of the parameter associated with the at least one type of unintentional distortion may increase the negative score assigned to the unintentional distortion(s) in the content item during the quality assessment process. Data indicative of the increased weight of the parameter associated with the at least one type of unintentional distortion may be stored as parameter data 110.

If the classification indicative of the quality type associated with the content item indicates that the content item is associated with the second quality type, this may indicate that the content item is not an original content item (e.g., not the original uncompressed source copy). If the content item is not an original content item, this may indicate that the content item is associated with at least one second type of distortion. The at least one second type of distortion may comprise at least one unintentional distortion. It may be desirable to negatively score the unintentional distortion(s) in the content item, as the unintentional distortion(s) are indicative of low video quality.

Thus, if the content item is classified as being associated with the second quality type, adjusting a weight of a parameter associated with at least one type of distortion may comprise increasing a weight of a parameter associated with at least one type of unintentional distortion. Increasing the weight of the parameter associated with the at least one type of unintentional distortion may increase the negative score assigned to the unintentional distortion(s) in the content item during the quality assessment process. Data indicative of the increased weight of the parameter associated with the at least one type of unintentional distortion may be stored as parameter data 110.

Determining the process for assessing the quality associated with the content item may comprise disabling at least one parameter associated with at least one type of distortion. If the classification indicative of the quality type associated with the content item indicates that the content item is associated with the first quality type, this may indicate that the content item is an original content item. If the content item is an original content item, this may indicate that the content item is associated with at least one first type of distortion. The at least one first type of distortion may comprise at least one intentional distortion. It may be undesirable to negatively score the intentional distortion(s) in an original content item, as the intentional distortion(s) are not indicative of low video quality. Thus, if the content item is classified as being associated with the first quality type, at least one parameter associated with the at least one first type of distortion may be disabled. Disabling at least one parameter associated with the at least one first type of distortion may prevent the intentional distortion(s) in the content item from being negatively scored during the quality assessment process. Data indicative of the disabled parameter(s) may be stored as parameter data 110.

The computing device 104 may be configured to assess (e.g., determine) the quality associated with the content item. The computing device 104 may be configured to assess the quality associated with the content item by performing the process for assessing the quality associated with the content item. Performing the process for assessing the quality associated with the content item may comprise evaluating the at least one algorithm. The at least one algorithm may be evaluated based on the algorithm data 108 and/or the parameter data 110. Performing the process for assessing the quality associated with the content item may comprise assessing the quality associated with the content item by evaluating the at least one algorithm based on the adjusted parameter weight(s).

Based on performing the process for assessing the quality associated with the content item, the computing device 104 may determine a score indicative of the quality associated with the content item. The computing device 104 may cause the score indicative of the quality associated with the content item to be stored as quality score data 112. The computing device 104 may cause output of the score indicative of the video quality associated with the content item. The content device(s) 102 may utilize the quality score data 112 to assess the quality of a content item before distributing the content item to the plurality of client devices 115a-n. Additionally, or alternatively, the content device(s) 102 may cause output of the quality score data 112 to the plurality of client devices 115a-n so that the users associated with the plurality of client devices 115a-n are able to quickly assess content quality before selecting a content item for consumption.

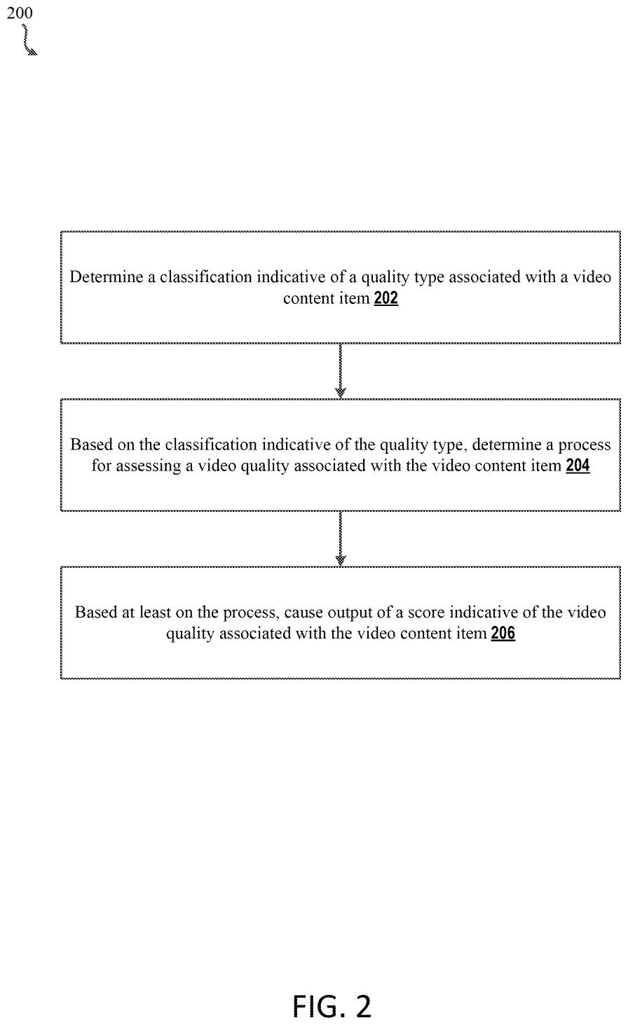

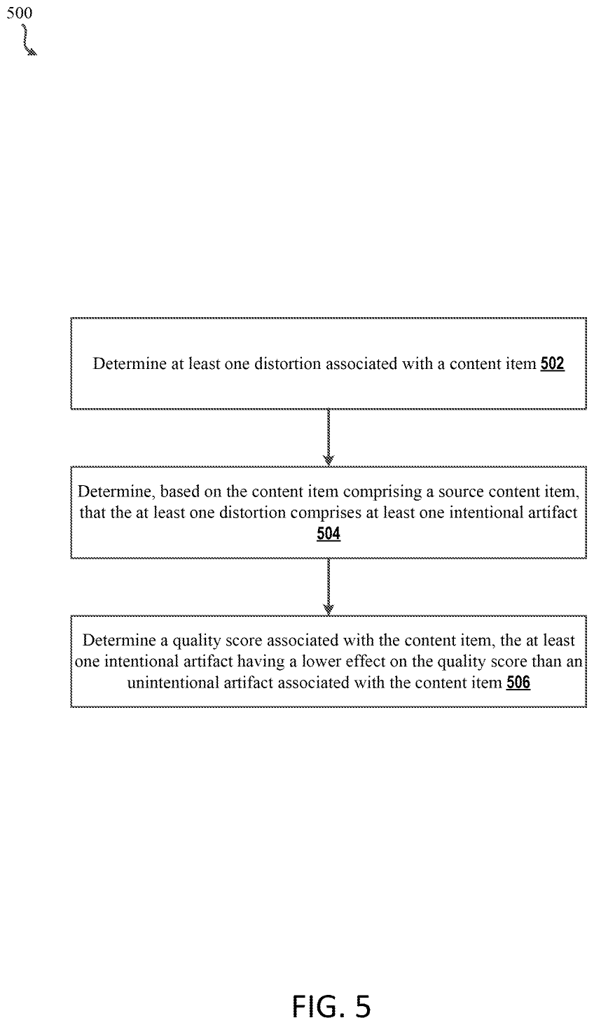

FIG. 2 is an example method 200. The method 200 may comprise a computer implemented method for determining content quality. A system and/or computing environment, such as the system 100 of FIG. 1 and/or the computing environment of FIG. 5, may be configured to perform the method 200. For example, the computing device 104 of FIG. 1 may be configured to perform the method 200.

Some distortions (e.g., video artifacts) in content items are intentionally included in the content item by the creator of the content item. Other distortions (e.g., video artifacts) in content items are not intentionally included in the content item by the creator of the content item. Such unintentional distortions may be generated during processing (e.g., editing, compressing, or de-compressing, format changes, transmission, etc.) of the content item.

Distortions in a video content item that has not been processed may be determined to be intentional distortions. At 202, a classification may be determined. The classification may be indicative of a quality type associated with a video content item. Determining the classification indicative of the quality type associated with the video content item may comprise determining whether the video content item is associated with a first quality type or a second quality type. Determining the classification indicative of the quality type associated with the video content item may comprise classifying the video content item as either being associated with the first quality type or the second quality type. Determining the classification indicative of the quality type associated with the video content item may comprise determining the classification based on at least a portion of data and/or metadata associated with the video content item. Determining the classification indicative of the quality type associated with the video content item may comprise determining the classification based on a trained machine learning model.

If the video content item is classified as being associated with the first quality type, this may indicate that the content item is an original (e.g., source) content item. The content item may be an original (e.g., source) content item if the content item has not been processed (e.g., editing, compressing, or de-compressing, format changes, transmission, etc.). Thus, determining that the video content item is associated with the first quality type may comprise determining that the content item is associated with at least one first type of distortion (e.g., video artifact). The at least one first type of distortion may comprise at least one intentional distortion. If the video content item is classified as being associated with the second quality type, this may indicate that the video content item is not an original content item (e.g., not the original uncompressed source copy). The content item may not be an original (e.g., source) content item if the content item has been processed (e.g., editing, compressing, or de-compressing, format changes, transmission, etc.). Thus, determining that the video content item is associated with the second quality type may comprise determining that the video content item is associated with at least one second type of distortion. The at least one second type of distortion may comprise at least one unintentional distortion.

To determine a quality score associated with a content item, a process for assessing a quality associated with the content item may be determined. Intentional artifacts may not be considered and/or may be assigned less weight (e.g., importance) than unintentional artifacts in the process for assessing a quality associated with the content item. At 204, a process for assessing a video quality associated with the video content item may be determined. The process may be determined based on the classification indicative of the quality type. The process for assessing the quality associated with the content item may comprise at least one algorithm configured to determine content quality based on distortions (e.g., video artifacts) associated with the content item. The at least one algorithm may be associated with a plurality of parameters. Each of the plurality of parameters may be associated with a particular type of distortion. For example, a first parameter may be associated with mosquito noise, a second parameter may be associated with blockiness, a third parameter may be associated with blurriness, etc. Determining the process for assessing the quality associated with the content item may comprise adjusting a weight of a parameter associated with at least one type of distortion.

To assess (e.g., determine) the quality associated with the content item, the process may be performed. At 206, output of a score may be caused. The score may be indicative of the video quality associated with the video content item. The output of the score may be caused based at least on the process. To assess (e.g., determine) the quality associated with the content item, the at least one algorithm may be evaluated.

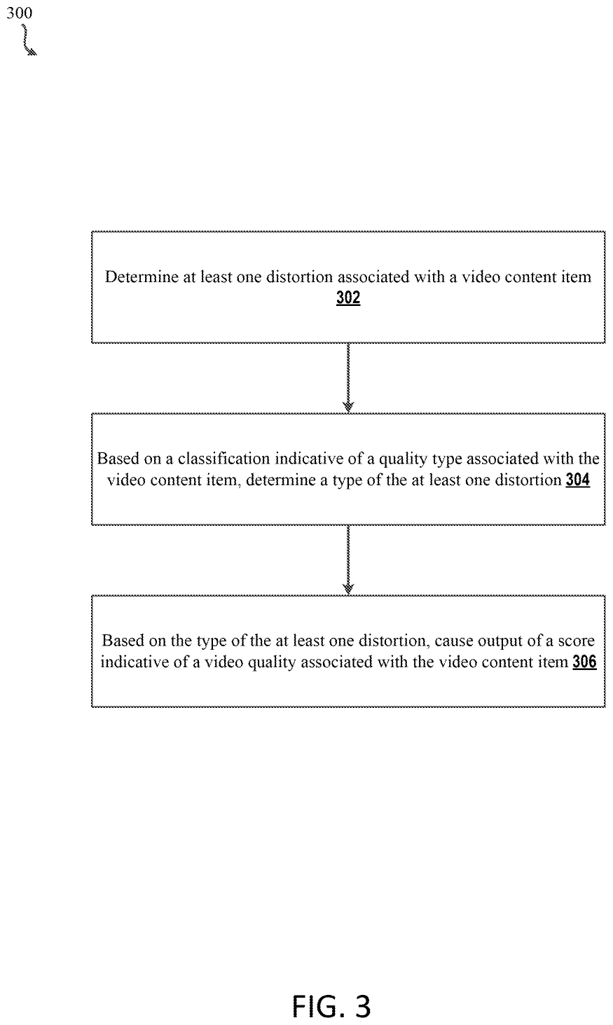

FIG. 3 is an example method 300. The method 300 may comprise a computer implemented method for determining content quality. A system and/or computing environment, such as the system 100 of FIG. 1 and/or the computing environment of FIG. 5, may be configured to perform the method 300. For example, the computing device 104 of FIG. 1 may be configured to perform the method 300.

At 302, at least one distortion (e.g., video artifact) may be determined. The at least one distortion may be associated with a video content item. The at least one distortion may comprise one or more of a basis pattern, blockiness, blurriness, color distortion, mosquito noise, white noise, graininess, ringing, flickering, floating, jerkiness, incorrect or incoherent captions or subtitles, and/or any other type of visual or auditory distortion. The at least one distortion may comprise at least one intentional distortion and/or at least one unintentional distortion.

At 304, a type of the at least one distortion may be determined. The type of the at least one distortion may be determined based on a classification indicative of a quality type associated with the video content item. The classification indicative of the quality type associated with the content item may indicate whether the video content item is associated with a first quality type or a second quality type. If the video content item is classified as being associated with the first quality type, this may indicate that the content item is an original content item. Thus, if the video content item is classified as being associated with the first quality type, it may be determined that the at least one distortion is at least one first type of distortion. The at least one first type of distortion may comprise at least one intentional distortion. If the video content item is classified as being associated with the second quality type, this may indicate that the video content item is not an original content item (e.g., not the original uncompressed source copy). Thus, if the video content item is classified as being associated with the second quality type, it may be determined that the at least one distortion is at least one second type of distortion. The at least one second type of distortion may comprise at least one unintentional distortion.

At 306, output of a score may be caused. The score may be indicative of a video quality associated with the video content item. Output of the score may be caused based on the type of the at least one distortion. To determine a quality score associated with a content item, a process for assessing a quality associated with the content item may be determined based on the type of at least one distortion. The process for assessing the quality associated with the content item may comprise at least one algorithm configured to determine content quality based on distortions (e.g., impairments) associated with the content item. Output of the score may be caused based on performing the process for assessing the video quality associated with the video content item.

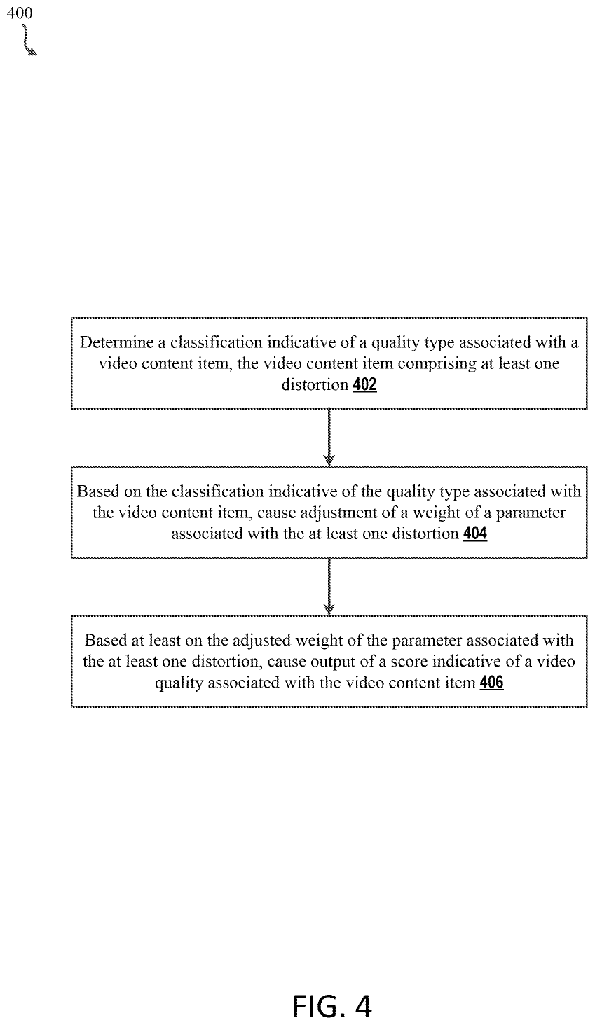

FIG. 4 is an example method 400. The method 400 may comprise a computer implemented method for determining content quality. A system and/or computing environment, such as the system 100 of FIG. 1 and/or the computing environment of FIG. 5, may be configured to perform the method 400. For example, the computing device 104 of FIG. 1 may be configured to perform the method 400.

At 402, a classification may be determined. The classification may be indicative of a quality type associated with a video content item. The video content item may comprise at least one distortion. Determining the classification indicative of the quality type associated with the video content item may comprise determining whether the video content item is associated with a first quality type or a second quality type. Determining the classification indicative of the quality type associated with the video content item may comprise classifying the video content item as either being associated with the first quality type or the second quality type. Determining the classification indicative of the quality type associated with the video content item may comprise determining the classification based on at least a portion of data and/or metadata associated with the video content item. Determining the classification indicative of the quality type associated with the video content item may comprise determining the classification based on a trained machine learning model.

If the video content item is classified as being associated with the first quality type, this may indicate that the content item is an original content item. Thus, determining that the video content item is associated with the first quality type may comprise determining that the content item is associated with at least one first type of distortion (e.g., video artifact). The at least one first type of distortion may comprise at least one intentional distortion (e.g., intentional artifact). If the video content item is classified as being associated with the second quality type, this may indicate that the video content item is not an original content item (e.g., not the original uncompressed source copy). Thus, determining that the video content item is associated with the second quality type may comprise determining that the video content item is associated with at least one second type of distortion. The at least one second type of distortion may comprise at least one unintentional distortion.

A process for assessing the quality associated with the content item may comprise at least one algorithm configured to determine content quality based on distortions (e.g., video artifacts, impairments) associated with the content item. The at least one algorithm may be associated with at least one parameter. At 404, adjustment of a weight of a parameter may be caused. The parameter may be associated with the at least one distortion. The weight of a parameter may be caused to be adjusted based on the classification indicative of the quality type associated with the video content item.

If the content item is classified as being associated with the first quality type, adjusting the weight of the parameter may comprise decreasing a weight of a parameter associated with at least one type of intentional distortion. Decreasing the weight of the parameter associated with the at least one type of intentional distortion may comprise adjusting the weight of the parameter associated with the at least one type of intentional distortion to zero. Decreasing the weight of the parameter associated with the at least one type of intentional distortion may prevent the intentional distortion(s) in the content item from being negatively scored during the quality assessment process. If the content item is classified as being associated with the first quality type, adjusting the weight of the parameter may comprise increasing a weight of a parameter associated with at least one type of unintentional distortion. The at least one type of unintentional distortion may comprise a type of unintentional distortion that is unlikely to be intentionally included in content, such as mosquito noise, white noise, ringing, flickering, floating, jerkiness, incorrect or incoherent captions or subtitles, etc. Increasing the weight of the parameter associated with the at least one type of unintentional distortion may increase the negative score assigned to the unintentional distortion(s) in the content item during the quality assessment process.

If the content item is classified as being associated with the second quality type, adjusting the weight of the parameter may comprise increasing a weight of a parameter associated with at least one type of unintentional distortion. Increasing the weight of the parameter associated with the at least one type of unintentional distortion may increase the negative score assigned to the unintentional distortion(s) in the content item during the quality assessment process.

At 406, output of a score may be caused. The score may be indicative of the video quality associated with the video content item. The output of the score may be caused based at least on the adjusted weight of the parameter associated with the at least one distortion. The output of the score may be caused based on evaluating the at least one algorithm.

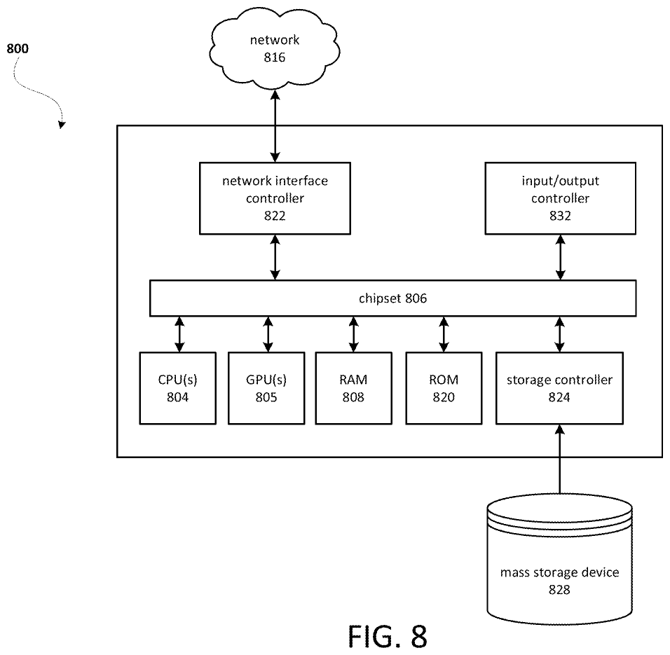

FIG. 5 is an example method 500. The method 500 may comprise a computer implemented method for determining content quality. A system and/or computing environment, such as the system 100 of FIG. 1 and/or the computing environment of FIG. 8, may be configured to perform the method 500. For example, the computing device 104 of FIG. 1 may be configured to perform the method 500.

At 502, at least one distortion (e.g., video artifact) may be determined. The at least one distortion may be associated with a video content item. The at least one distortion may comprise one or more of a basis pattern, blockiness, blurriness, color distortion, mosquito noise, white noise, graininess, ringing, flickering, floating, jerkiness, incorrect or incoherent captions or subtitles, and/or any other type of visual or auditory distortion. The at least one distortion may comprise at least one intentional distortion and/or at least one unintentional distortion.

At 504, it may be determined that the at least one distortion comprises at least one intentional artifact. It may be determined that the at least one distortion comprises at least one intentional artifact based on the video content item comprising a source (e.g., original) content item. Determining that the content item comprises a source content item may comprise determining that the content item has not been edited. Determining that the content item comprises a source content item may comprise determining that the content item has not been compressed. Determining that the content item comprises a source content item may comprise determining that the content item has not been de-compressed. It may be determined that the content item comprises a source content item using a machine learning model. The machine learning model may be trained to determine whether content has been edited, compressed, or de-compressed. It may be determined that the content item comprises a source content item using data associated with the content item. The data associated with the content item may be indicative of at least one of frame rate, resolution, audio bitrate, video bitrate, subtitle formats, container format, codec identifier, duration, width, height, color space, resolution, chroma subsampling, bit depth, scan type, compression mode, or stream size.

At 506, a quality score may be determined. The quality score may be associated with the content item. The quality score may be indicative of the video quality associated with the video content item. The at least one intentional artifact may have a lower effect on the quality score than an unintentional artifact associated with the content item. Determining the quality score associated with the content item may comprise determining at least one parameter of a content quality algorithm. The at least one parameter may be associated with the at least one intentional artifact. Determining the quality score associated with the content item may comprise disabling the at least one parameter associated with the at least one intentional artifact associated with the at least one intentional artifact. Disabling and/or decreasing the weight of the at least one parameter associated with the at least one intentional artifact may cause the at least one intentional artifact to have a lower effect on the quality score than an unintentional artifact associated with the content item. One or more different parameters associated with unintentional artifacts may not be disabled. Determining the quality score associated with the content item may comprise decreasing a weight associated with the at least one parameter associated with the at least one intentional artifact. A weight associated with one or more different parameters associated with unintentional artifacts may not be decreased. A weight associated with one or more different parameters associated with unintentional artifacts may be increased. The determined quality score may be output.

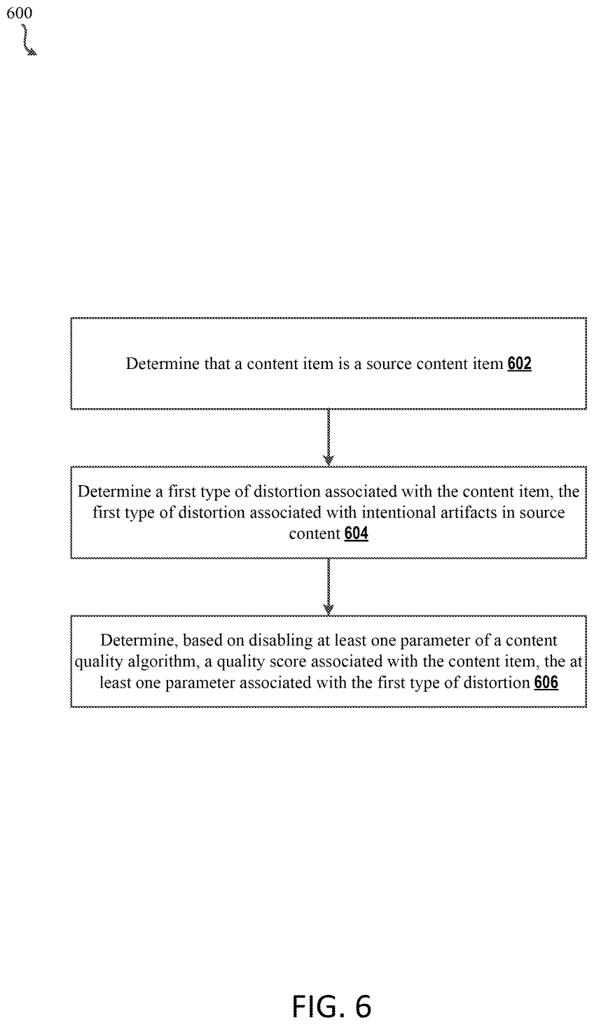

FIG. 6 is an example method 600. The method 600 may comprise a computer implemented method for determining content quality. A system and/or computing environment, such as the system 100 of FIG. 1 and/or the computing environment of FIG. 8, may be configured to perform the method 600. For example, the computing device 104 of FIG. 1 may be configured to perform the method 600.

At 602, it may be determined that a content item is a source (e.g., original) content item. Determining that the content item comprises a source content item may comprise determining that the content item has not been edited. Determining that the content item comprises a source content item may comprise determining that the content item has not been compressed. Determining that the content item comprises a source content item may comprise determining that the content item has not been de-compressed. It may be determined that the content item comprises a source content item using a machine learning model. The machine learning model may be trained to determine whether content has been edited, compressed, or de-compressed. It may be determined that the content item comprises a source content item using data associated with the content item. The data associated with the content item may be indicative of at least one of frame rate, resolution, audio bitrate, video bitrate, subtitle formats, container format, codec identifier, duration, width, height, color space, resolution, chroma subsampling, bit depth, scan type, compression mode, or stream size.

At 604, a first type of distortion may be determined. The first type of distortion may be associated with the content item. The first type of distortion may be associated with intentional artifacts in source content. The first type of distortion may comprise a type of intentional distortion that is likely to be intentionally included in content. The first type of distortion may comprise one or more of a basis pattern, blockiness, blurriness, color distortion, mosquito noise, white noise, graininess, ringing, flickering, floating, jerkiness, and/or the like. A second type of distortion may be determined. The second type of distortion may be associated with the content item. The second type of distortion may be associated with unintentional artifacts. The second type of distortion may comprise a type of unintentional distortion that is unlikely to be intentionally included in content. The second type of distortion may comprise one or more of a basis pattern, blockiness, blurriness, color distortion, mosquito noise, white noise, graininess, ringing, flickering, floating, jerkiness, and/or the like. The second type of distortion may be different from the first type of distortion.

Distortions of the first type of distortion (e.g., distortions that were likely to be intentionally included in content) are not included in quality of video analysis. Distortions of the first type of distortion may have no effect on the quality score or a lower effect on the quality score than an unintentional artifact associated with the content item. Thus, the quality score associated with the content item may not incorrectly indicate that the content item is of low quality based on the distortions that were intentionally included in the content item.

At 606, a quality score may be determined. The quality score may be associated with the content item. The quality score may be determined based on disabling at least one parameter of a content quality algorithm. The at least one parameter may be associated with the first type of distortion. Disabling the at least one parameter of the content quality algorithm may comprise not determining a value of the at least one parameter. The quality score may be determined based on determining a value of at least one different parameter. The at least one different parameter may be associated with the second type of distortion. The determined quality score may be output.

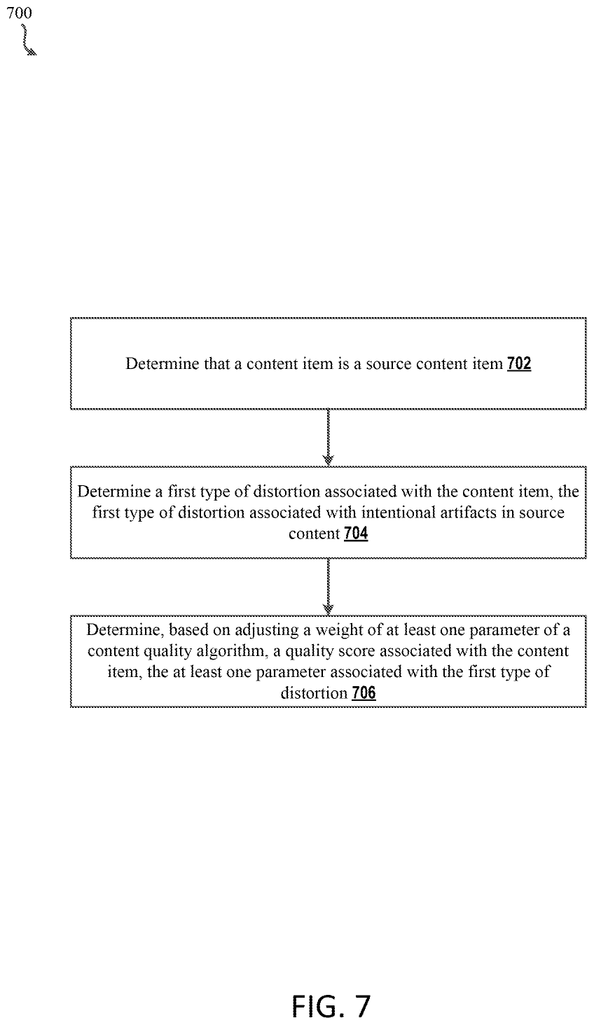

FIG. 7 is an example method 700. The method 700 may comprise a computer implemented method for determining content quality. A system and/or computing environment, such as the system 100 of FIG. 1 and/or the computing environment of FIG. 8, may be configured to perform the method 700. For example, the computing device 104 of FIG. 1 may be configured to perform the method 700.

At 702, it may be determined that a content item is a source (e.g., original) content item. Determining that the content item comprises a source content item may comprise determining that the content item has not been edited. Determining that the content item comprises a source content item may comprise determining that the content item has not been compressed. Determining that the content item comprises a source content item may comprise determining that the content item has not been de-compressed. It may be determined that the content item comprises a source content item using a machine learning model. The machine learning model may be trained to determine whether content has been edited, compressed, or de-compressed. It may be determined that the content item comprises a source content item using data associated with the content item. The data associated with the content item may be indicative of at least one of frame rate, resolution, audio bitrate, video bitrate, subtitle formats, container format, codec identifier, duration, width, height, color space, resolution, chroma subsampling, bit depth, scan type, compression mode, or stream size.

At 704, a first type of distortion may be determined. The first type of distortion may be associated with the content item. The first type of distortion may be associated with intentional artifacts in source content. The first type of distortion may comprise a type of intentional distortion that is likely to be intentionally included in content. The first type of distortion may comprise one or more of a basis pattern, blockiness, blurriness, color distortion, mosquito noise, white noise, graininess, ringing, flickering, floating, jerkiness, and/or the like. A second type of distortion may be determined. The second type of distortion may be associated with the content item. The second type of distortion may be associated with unintentional artifacts. The second type of distortion may comprise a type of unintentional distortion that is unlikely to be intentionally included in content. The second type of distortion may comprise one or more of a basis pattern, blockiness, blurriness, color distortion, mosquito noise, white noise, graininess, ringing, flickering, floating, jerkiness, and/or the like. The second type of distortion may be different from the first type of distortion.

At 706, a quality score may be determined. The quality score may be associated with the content item. The quality score may be determined based on adjusting a weight of at least one parameter of a content quality algorithm. The at least one parameter may be associated with the first type of distortion. Adjusting the weight of the at least one parameter of the content quality algorithm may comprise decreasing the weight of the at least one parameter. Decreasing the weight of the at least one parameter may comprise decreasing the weight to zero and/or to any other value lower than the current or default parameter value. The quality score may be determined based on maintaining or adjusting a weight of at least one different parameter of the content quality algorithm. The at least one different parameter may be associated with the second type of distortion. Adjusting the weight of the at least one different parameter of the content quality algorithm may comprise increasing the weight of the at least one different parameter. Increasing the weight of the at least one different parameter may comprise increasing the weight to any other value higher than the current or default parameter value.

FIG. 8 depicts a computing device that may be used in various aspects, such as the servers and/or devices depicted in FIG. 1. With regard to the example architecture of FIG. 1, the content device(s) 102, the plurality of client devices 115a-n, the computing device 104, and/or the classifier(s) 132 may each be implemented in an instance of a computing device 800 of FIG. 8.

The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIG. 3, FIG. 4, and FIG. 8.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 808 used as the main memory in the computing device 800. The chipset 806 may further provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 828 by detecting the physical states or characteristics of one or more particular locations within the physical storage units.

In addition to the mass storage device 828 described above, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described above. The computing device 800 may have access to computer-readable storage media storing computer-executable instructions, which, when executed by the computing device 800, may perform the methods described in relation to FIG. 2-FIG. 7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
determining at least one distortion associated with a content item;
determining, based on the content item comprising a source content item, that the at least one distortion comprises at least one intentional artifact; and
determining a quality score associated with the content item, wherein the at least one intentional artifact has no effect on the quality score.

2. The method of claim 1, further comprising determining that the content item comprises a source content item, wherein determining that the content item comprises a source content item comprises at least one of determining that the content item has not been edited, determining that the content item has not been compressed, or determining that the content item has not been de-compressed.

3. The method of claim 1, further comprising determining that the content item comprises a source content item using a machine learning model, wherein the machine learning model is trained to determine whether content has been edited, compressed, or de-compressed.

4. The method of claim 1, further comprising determining that the content item comprises a source content item using data associated with the content item, wherein the data associated with the content item is indicative of at least one of frame rate, resolution, audio bitrate, video bitrate, subtitle formats, container format, codec identifier, duration, width, height, color space, resolution, chroma subsampling, bit depth, scan type, compression mode, or stream size.

5. The method of claim 1, wherein determining the quality score associated with the content item comprises determining at least one parameter of a content quality algorithm, wherein the at least one parameter is associated with the at least one intentional artifact.

6. The method of claim 5, wherein determining the quality score associated with the content item further comprises at least one of disabling the at least one parameter or decreasing a weight associated with the at least one parameter.

7. The method of claim 1, wherein the at least one distortion associated with the content item comprises at least one of a basis pattern, blockiness, blurriness, color distortion, mosquito noise, white noise, graininess, ringing, flickering, floating, or jerkiness.

8. The method of claim 1, wherein the content item comprises at least one of an image or a video.

9. The method of claim 1, wherein the source content item comprises a content item that has not been edited, compressed, or de-compressed.

10. A method comprising:
determining that a content item is a source content item;
determining a first type of distortion associated with the content item, wherein the first type of distortion is associated with intentional artifacts in source content; and
determining, based on adjusting at least one parameter of a content quality algorithm, a quality score associated with the content item, wherein the at least one parameter is associated with the first type of distortion.

11. The method of claim 10, wherein determining that the content item is a source content item comprises at least one of determining that the content item has not been edited, determining that the content item has not been compressed, or determining that the content item has not been de-compressed.

12. The method of claim 10, wherein determining that the content item is a source content item comprises determining that the content item is a source content item using a machine learning model, wherein the machine learning model is trained to determine whether content has been edited, compressed, or de-compressed.

13. The method of claim 10, wherein determining that the content item is a source content item comprises determining that the content item is a source content item using data associated with the content item, wherein the data associated with the content item is indicative of at least one of frame rate, resolution, audio bitrate, video bitrate, subtitle formats, container format, codec identifier, duration, width, height, color space, resolution, chroma subsampling, bit depth, scan type, compression mode, or stream size.

14. The method of claim 10, wherein determining the quality score associated with the content item comprises evaluating the content quality algorithm.

15. The method of claim 10, wherein the first type of distortion associated with the content item comprises at least one of a basis pattern, blockiness, blurriness, color distortion, mosquito noise, white noise, graininess, ringing, flickering, floating, or jerkiness.

16. The method of claim 10, wherein the source content item comprises a content item that has not been edited, compressed, or de-compressed.

17. The method of claim 10, wherein adjusting the at least one parameter of the content quality algorithm comprises removing an effect of the at least one parameter on the quality score associated with the content item.

18. A method comprising:
determining that a content item is a source content item;
determining a first type of distortion associated with the content item, wherein the first type of distortion is associated with intentional artifacts in source content; and
determining a content quality for the content item without considering the first type of distortion.

19. The method of claim 18, wherein determining that the content item is a source content item comprises at least one of determining that the content item has not been edited, determining that the content item has not been compressed, or determining that the content item has not been de-compressed.

20. The method of claim 18, wherein determining that the content item is a source content item comprises determining that the content item is a source content item using a machine learning model, wherein the machine learning model is trained to determine whether content has been edited, compressed, or de-compressed.
